(19) United States
(12) Patent Application Publication
(10) Pub. No.: US 2019/0054372 A1
(43) Pub. Date: Feb. 21, 2019

(54) SELF-CHARGING KINETIC VIDEO GAME CONTROLLER

(71) Applicant: Jordan Morgan, Mount Dora, FL (US)

(72) Inventor: Jordan Morgan, Mount Dora, FL (US)

(21) Appl. No.: 16/104,468

(22) Filed: Aug. 17, 2018

Related U.S. Application Data
(60) Provisional application No. 62/547,581, filed on Aug. 18, 2017.

(51) Int. Cl. A63F 13/24; H02K 7/18; H02J 7/14

(52) U.S. Cl. CPC A63F 13/24; A63F 2300/1043; H02J 7/1423; H02K 7/1853

(57) ABSTRACT

A self-charging kinetic video game controller includes a controller body having a plurality of input members, a power source, and controller circuit. One or more power generation units are positioned within the controller body and are mechanically coupled to one or more of the input members by an elongated rod. The power generation unit including a kinetic drive assembly having a plurality of gears for converting linear motion to rotational motion, and a generator that transitions rotational motion into an electrical current for storage by the power source.

### CROSS-REFERENCE TO RELATED APPLICATIONS

This application claims the benefit of U.S. Application Ser. No. 62/547,581 filed on Aug. 18, 2017, the contents of which are incorporated herein by reference.

### TECHNICAL FIELD

The present invention relates generally to gaming devices, and more particularly to a self-charging video game controller.

### BACKGROUND

The statements in this section merely provide background information related to the present disclosure and may not constitute prior art.

Game controllers are manufactured in a myriad of different shapes and sizes and include a plurality of buttons for providing user inputs to an electronic device such as a video game console and/or a computer, for example.

Although game controllers were initially manufactured so as to be electrically tethered to the electronic console, modern controllers utilize a wireless communication system that is powered by a series of batteries. The batteries functioning to provide the necessary power requirements to the controller in order to allow the same to be linked with and transmit data to the gaming console. Over time, the power level of the batteries will drop, requiring the same to be replaced or recharged. In some instances, the batteries will die during game play, which can be a source of great aggravation to the user. Moreover, when utilizing rechargeable batteries, the user must plug or otherwise connect a battery charger to the game controller, thus making the console unavailable for play.

Accordingly, it would be beneficial to provide a self-charging game controller that can utilize kinetic energy to continuously charge the onboard batteries during game play, so as to alleviate the drawbacks described above.

### SUMMARY OF THE INVENTION

The present invention is directed to a self-charging kinetic video game controller. One embodiment of the present invention can include a controller body having a plurality of input members, a power source, and controller circuit for communicating with an electronic device. One or more power generation units can be positioned within the controller body and can be mechanically coupled to one or more of the input members, and electrically coupled to the power source.

In one embodiment, the power generation unit of the controller can include a kinetic drive assembly having a plurality of gears for converting linear motion to rotational motion. An elongated rod can be interposed between the connected input member and the kinetic drive assembly to receive a linear force via the depression of the connected input member. The kinetic drive assembly can be coupled to a generator which transitions the received rotational motion into an electrical current for storage by the power source.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a schematic front view of one embodiment of the self-charging kinetic video game controller that is useful for understanding the inventive concepts disclosed herein.

FIG. 2 is a schematic cross-sectional view of the self-charging kinetic video game controller, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Although described and illustrated with regard to a video game type of controller this is for illustrative purposes only. As such, any type of device having one or more input members can also utilize the inventive concepts described herein.

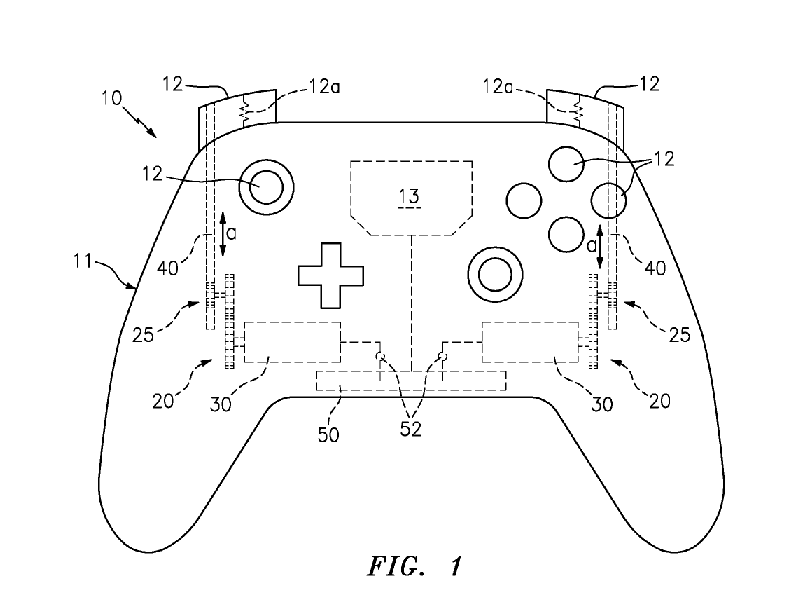

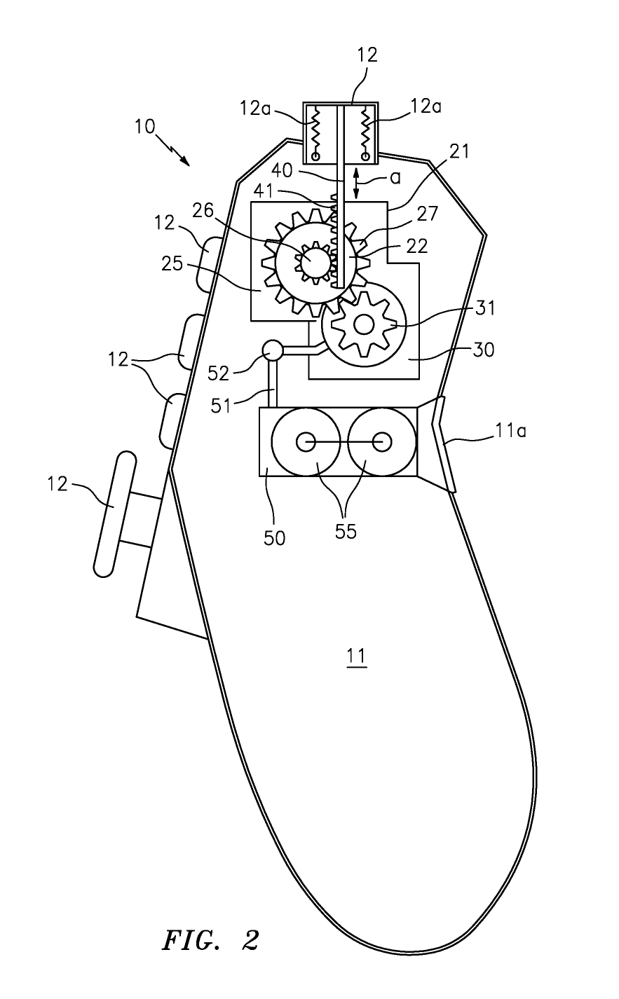

FIGS. 1 and 2 illustrate one embodiment of a self-charging kinetic video game controller 10 that is useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown throughout the drawings, the controller 10 can include a main body 11, a power generation unit 20 and a power source 50.

The main body 11 can include any number of different shapes, sizes and construction materials as are common for game-type controllers. A plurality of input members 12 such as various push buttons, function keys and/or joysticks, for example, can be secured along the main body at any location. Each of the input members can be in communication with a circuit board 13 that is positioned within the main body.

The circuit board 13 can function to wirelessly communicate with any number of different computers, or gaming systems such as an Xbox®, or PlayStation®, for example. Circuitry for performing this task is well known in the art, and may also include functionality for identifying and transmitting movement information of the controller 10 itself, as is also known in the art.

At least one power generation unit 20 can be positioned inside the main body 11 and can be in communication with one or more of the input members 12. Each of the power generation unit(s) can include a substantially hollow housing 21 and can function to convert the kinetic motion of the inputs 12 into electric current for storage by the power source.

As shown best in FIG. 2, the power generation unit 20 can include a kinetic drive assembly 25 and a generator 30 that are mechanically linked to an elongated rod 40. The kinetic drive assembly 25 is designed to translate the linear kinetic motion of the rod 40 into rotational kinetic motion, and can include a small drive gear 26, that is connected to a large drive gear 27 via a central shaft 28 extending outward from the large drive gear.

The elongated rod 40 can include a first end that is connected to one of the input members 12, and a second end that is positioned within the housing 21. The rod can also include a plurality of teeth 41 that are in communication with the small drive gear 26 of the kinetic drive assembly. In various embodiments, the main body can also include an internal support structure/guide 22 that ensures constant contact between the teeth 41 of the rod and the small gear 26, while allowing the rod 40 to move in a linear manner shown by arrow a.

In various embodiments, the teeth can be shaped so as to engage the small drive gear when traveling in two directions (e.g., down and up) thereby causing the gear to rotate in two directions. Such rotation will be in concert with the movement of the rod. Alternatively, the teeth 41 can be shaped so as to engage the small drive gear only when traveling in a first direction (e.g., down) so as to cause the gear to spin in a single direction. Such a feature can allow the force imparted by the movement in the first direction to continue spinning the small drive gear in the single direction even as the rod travels in a second direction.

Although described above with regard to specific components forming the kinetic drive assembly, this is for illustrative purposes only. To this end, any number of other devices and/or arrangement of components capable of translating linear motion to rotational motion are also contemplated.

The generator 30 can convert the rotational kinetic motion provided by the kinetic drive assembly into an electric current for use by the power source 50. In the preferred embodiment, the generator can be operationally coupled to the large drive gear 27 of the kinetic drive assembly 25 by a conversion gear 31 and can be electrically coupled to the power source 50 via wires 51. One suitable example of a generator for use herein can include the 3V DC electric generator that is commercially available from EUDAX. Of course, any number of other and/or different components are also contemplated.

In one embodiment, a diode 52 can be interposed between the generator and the power source. The diode can function in the expected manner to control current flowing from the generator and to prevent reverse biasing the batteries 50.

The power source 50 can function to provide the necessary power requirements for the controller 10. In the preferred embodiment, the power source can include, comprise or consist of a battery pack having any number of individual rechargeable batteries 55 that are arranged in any combination (e.g., series or parallel) suitable for use with the controller. In various embodiments, the battery pack can be permanently located within the main body or can be accessible via compartment having a removable cover 11a so as to be replaceable.

In operation, the controller 10 can function in the expected manner whereby the power source 50 provides power to the circuit board 13 that is wirelessly connected to a computer or gaming system. During play, a user will manipulate the content displayed by the gaming system via the inputs 12 and/or through the motion of the main body 11.

In addition to the above, the power generation unit will function to maintain the power source in a fully charged state by converting the linear motion of the connected inputs into electric current. In this regard, each time a user depresses a connected input 12, the rod 40 will move in a first direction toward the drive assembly 25. This movement will cause the teeth 41 to move linearly and the small gear 26 to rotate. This rotation will be mirrored by gears 27 and 31 causing the generator to spin and generate electric current for transmission to the power source 50. When the user disengages the connected input 12, trigger springs 12a or other such components will move the input and the rod 40 in a second direction away from the assembly at which time the process can be repeated.

Accordingly, the above described system alleviates the issues with the prior devices, and functions to actively charge the onboard power source during game play in a manner that is invisible to the user.

As described herein, one or more elements of the self-charging kinetic video game controller 10 can be secured together utilizing any number of known attachments means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A self-charging controller system, comprising:
a controller body having a plurality of input members and a generally hollow interior space;
a controller circuit that is positioned within the controller body and is in communication with each of the plurality of input members;
a power source that is positioned within the controller body and is in communication with the controller circuit; and
at least one power generation unit that is mechanically connected to one of the plurality of input members and is electrically coupled to the power source,
wherein each of the at least one power generation unit is configured to convert a movement of the connected input member into an electrical current for storage by the power source.

2. The system of claim 1, wherein each of the at least one power generation unit comprises a kinetic drive assembly and a generator.

3. The system of claim 2, wherein the kinetic drive assembly comprises:
a first drive gear;
a second drive gear; and
a central shaft that is in communication with each of the first drive gear and the second drive gear,
wherein the first drive gear includes a smaller diameter than the second drive gear.

4. The system of claim 3, further comprising:
an elongated rod having a first end that is coupled to the connected input member, and a second end that is in communication with the first drive gear,
wherein the elongated rod is configured to move linearly with a motion of the connected input member, and the kinetic drive assembly is configured to convert the linear motion to a rotational motion.

5. The system of claim 4, further comprising:
a conversion gear that is in communication with the second drive gear and the generator,
wherein the generator is configured to convert the rotational motion into the electrical current.

6. The system of claim 1, wherein the power source comprises:
a rechargeable battery pack.
